(19) United States
(12) Patent Application Publication
(10) Pub. No.: US 2019/0244335 A1
(43) Pub. Date: Aug. 8, 2019

(54) INFORMATION PROCESSING APPARATUS AND NON-TRANSITORY COMPUTER READABLE MEDIUM STORING PROGRAM

(71) Applicant: FUJI XEROX CO.,LTD., Tokyo (JP)

(72) Inventor: Ryoko USUBA, Kanagawa (JP)

(73) Assignee: FUJI XEROX CO.,LTD., Tokyo (JP)

(21) Appl. No.: 16/104,132

(22) Filed: Aug. 16, 2018

(30) Foreign Application Priority Data
Feb. 5, 2018 (JP) 2018-017964

(51) Int. Cl. G06T 7/00; G06K 9/62; G06T 7/136

(52) U.S. Cl. CPC G06T 7/001; G06Q 10/06398; G06T 7/136; G06K 9/6212

(57) ABSTRACT

An information processing apparatus includes an area division unit that performs an area division process with respect to an image indicated by captured data acquired by capturing a state of a work performed by a worker, and that divides the image into plural partial areas, a captured data division unit that divides the captured data into plural unit work data at a timing when a parameter relevant to a change in a feature value of the image for each of the partial areas satisfies a predetermined condition, a selection unit that selects the unit work data having a feature, which satisfies the predetermined condition, from the plural unit work data, and a presentation unit that presents the selected unit work data.

### CROSS-REFERENCE TO RELATED APPLICATIONS

This application is based on and claims priority under 35 USC 119 from Japanese Patent Application No. 2018-017964 filed Feb. 5, 2018.

### BACKGROUND

### (i) Technical Field

The present invention relates to an information processing apparatus and a non-transitory computer readable medium storing a program.

### (ii) Related Art

A technology for supporting a work in a factory or an office is proposed. For example, as an apparatus which performs classification on an operation of a subject, such as a person, in order to evaluate the work, JP2005-267604A discloses an operation classification support apparatus that includes a section that acquires a plurality of image data obtained by imaging the subject, a section that generates predetermined part information relevant to an imaging state of at least one predetermined part of the subject included in the acquired image data, or a section that performs classification on the operation of the subject based on the predetermined part information.

In addition, as a work evaluation apparatus which evaluates the work performed by a worker using moving image data acquired in such a way that an imaging apparatus captures the worker in a production site, JP2008-225704A discloses an apparatus which specifies a fact that a useless operation is performed in a case where a workload of the worker is large. In addition, as a technology for efficiently presenting information, which is necessary to increase work efficiency, JP2011-134224A discloses a technology which images a state of the work of the worker using a camera, and presents moving images of first three works, which are selected from a point of view of short work time of the work, as sample images to the worker.

### SUMMARY

In a case where comparison is performed on work time for each previously set work procedure and an improvement method with respect to a specified improvement spot is presented, a detailed improvement method is not understood in a case where granularity of the work procedure is too large and it is complicated to present an improved work in a case where the granularity of the work procedure is too small.

Aspects of non-limiting embodiments of the present disclosure relate to a technic capable of performing comparison on work time for each previously set work procedure and performs comparison on a case where an improvement method with respect to a specified improvement spot is presented, thereby causing a worker to easily grasp a detailed improvement method of a work.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided an information processing apparatus including: an area division unit that performs an area division process with respect to an image indicated by captured data acquired by capturing a state of a work performed by a worker, and that divides the image into a plurality of partial areas; a captured data division unit that divides the captured data into a plurality of unit work data at a timing when a parameter relevant to a change in a feature value of the image for each of the partial areas satisfies a predetermined condition; a selection unit that selects the unit work data having a feature, which satisfies the predetermined condition, from the plurality of unit work data; and a presentation unit that presents the selected unit work data.

### BRIEF DESCRIPTION OF THE DRAWINGS

Exemplary embodiment(s) of the present invention will be described in detail based on the following figures, wherein:

FIG. 1 is a diagram illustrating a configuration of a work support system;

FIG. 2 is a diagram illustrating a functional configuration of the work support system;

FIG. 3 is a diagram illustrating a hardware configuration of an information processing apparatus;

FIG. 4 is a flowchart illustrating a flow of a process of the information processing apparatus;

FIG. 5 is a diagram illustrating content of division reference data;

FIG. 6 is a flowchart illustrating a flow of a division process into major procedures;

FIGS. 7A to 7D are diagrams illustrating content of an area division process;

FIG. 8 is a flowchart illustrating a flow of a division process into sub procedures;

FIG. 9 is a diagram illustrating a flow of a work;

FIG. 10 is a graph illustrating a change in a feature value of an image for each partial area;

FIGS. 11A to 11C are diagrams illustrating a state in which division into the sub procedures is performed;

FIGS. 12A to 12C are diagrams illustrating content of a candidate work selection process; and

FIG. 13 is a diagram illustrating a displayed screen.

### DETAILED DESCRIPTION

1. Configuration

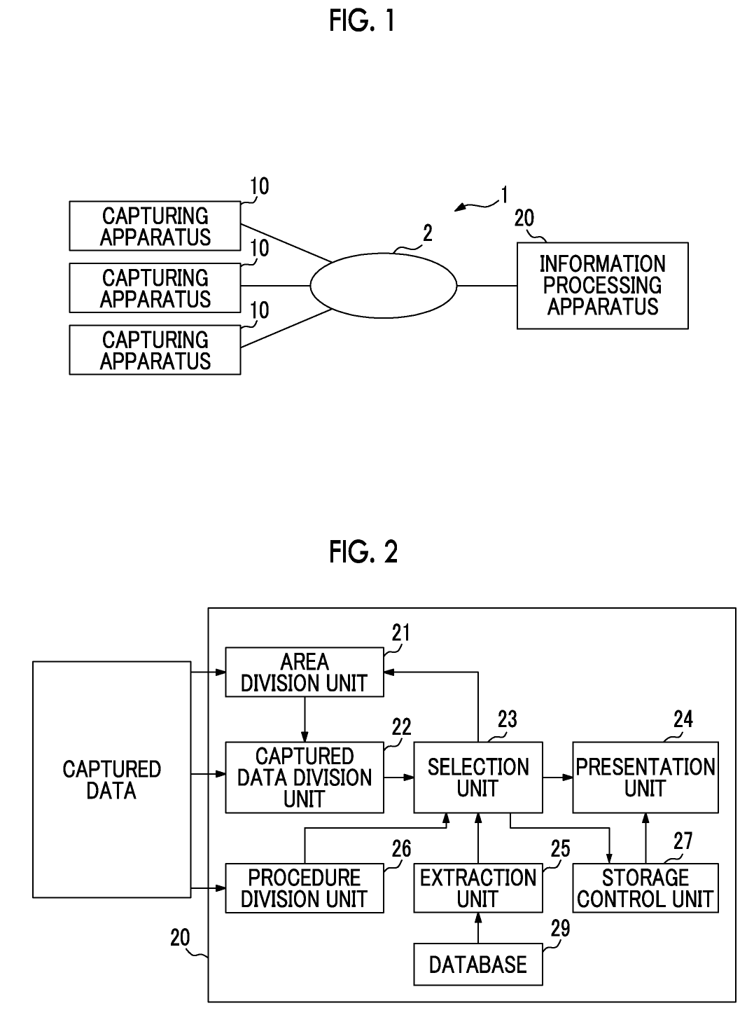

FIG. 1 is a block diagram illustrating a configuration of a work support system 1 according to an exemplary embodiment. The work support system 1 is a system which supports improvement of work efficiency of a worker. The work support system 1 includes a plurality of capturing apparatuses 10 and an information processing apparatus 20. The capturing apparatus 10 is an apparatus which captures a state of work performed by the worker. The information processing apparatus 20 is a computer apparatus such as a server apparatus, a smart phone, a tablet terminal, or a notebook-type Personal Computer (PC). The capturing apparatus 10 is connected to the information processing apparatus 20 through a communication line 2. The communication line 2 includes, for example, at least one of the Internet, a mobile communication network, a telephone line, a Local Area Network (LAN), or the like. Meanwhile, although FIG. 1 illustrates three capturing apparatuses 10, the number of capturing apparatuses 10 maybe larger or smaller than three.

FIG. 2 is a block diagram illustrating a functional configuration of the work support system 1. In FIG. 2, an area division unit 21 performs an area division process with respect to an image indicated by captured data acquired by capturing a state of the work performed by the worker, and divides the image into a plurality of partial areas. The captured data division unit 22 divides the captured data into a plurality of unit work data at a timing when a parameter relevant to a change in a feature value of the image for each partial area satisfies a predetermined condition. For example, an optical flow, a color histogram, and the like are used for the division process. In the exemplary embodiment, the feature value of the image is acquired by digitizing, for example, a feature of an image, such as a tone or brightness. The parameter relevant to the change in the feature value of the image is, for example, a parameter which indicates a variation in a vector in the optical flow.

The selection unit 23 selects a plurality of unit work data whose feature satisfies the predetermined condition. In addition, in a case where a difference between a feature of the unit work data and a feature of index data is smaller than a predetermined threshold, the selection unit 23 instructs the area division unit 21 to execute the area division process again. In this case, the area division unit 21 executes the area division process again using a parameter in which a division degree is finer than last time. The presentation unit 24 presents the unit work data which is selected by the selection unit 23.

The extraction unit 25 extracts the index data corresponding to a label attached to the unit work data acquired through division from a database 29 which stores a plurality of captured data. The extracted index data is used for the selection process performed by the selection unit 23.

The procedure division unit 26 compares the captured data with division reference data, which indicates an image used to specify a pause of a work, and divides the captured data into a plurality of procedures using a result of comparison. In each of the plurality of procedures acquired through division, the unit work data is selected by the selection unit 23.

The storage control unit 27 stores history of selection performed by the selection unit 23. The image, which indicates the unit work data specified by the stored history, is displayed together with the image, which indicates the selected unit work data, by the presentation unit 24.

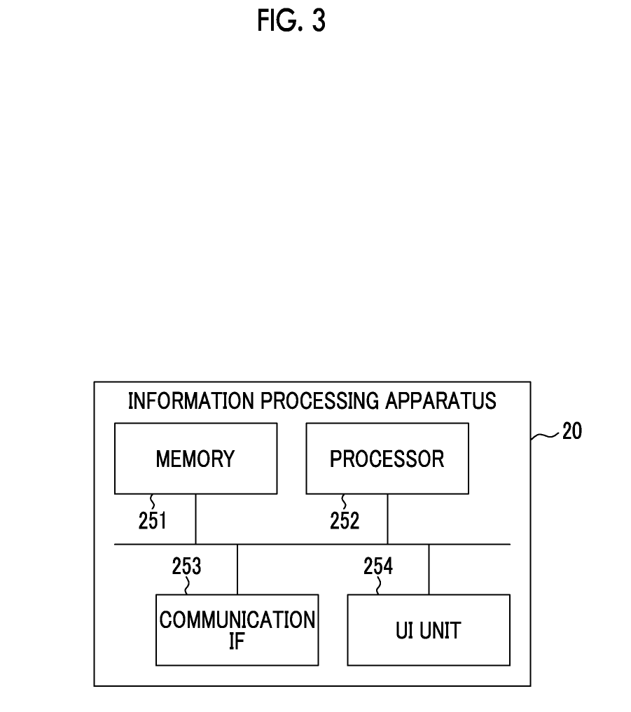

FIG. 3 is a diagram illustrating a hardware configuration of the information processing apparatus 20. In FIG. 3, a memory 251 stores various data. A processor 252 performs a data process according to a program stored in the memory 251. A communication IF 253 is an interface which performs data communication with an external apparatus through a network. An UI unit 254 includes, for example, a touch screen and keys . The UI unit 254 may be built in the information processing apparatus 20 and, in addition, may be attached to an outside and be connected to the outside.

In the example, in a case where the processor 252 executes the program stored in the memory 251, functions illustrated in FIG. 2 are mounted. The processor 252, which executes the program, is an example of the area division unit 21, the captured data division unit 22, the selection unit 23, the presentation unit 24, the extraction unit 25, the procedure division unit 26, and the storage control unit 27.

2. Operation

Subsequently, an operation according to the exemplary embodiment will be described. In the exemplary embodiment, the state of the work performed by the worker is captured by the capturing apparatus 10, the captured data is analyzed by the information processing apparatus 20, and information used to improve the work efficiency is presented to the worker. The work performed by the worker includes, for example, a work for exchanging components of an apparatus, such as an image forming apparatus, a work for assembling the components in a factory, and the like. The work performed by the worker includes one or more work procedures. For example, a work for exchanging a cartridge of the image forming apparatus includes a plurality of procedures as the work procedures, that is, a procedure for opening a cover (front panel) of the apparatus, a procedure for extracting the cartridge, a procedure for inserting the cartridge, and a procedure for closing the cover. In addition, there is a case where the work procedure further includes a plurality of sub procedures. For example, the procedure for opening the cover of the apparatus includes a plurality of sub procedures for preparing a driver, loosening a (first) screw, placing the screw, loosening a (second) screw, placing the screw, . . . .

In the exemplary embodiment, each procedure, which is acquired in a case where one work is divided into the plurality of procedures, is referred to as a “major procedure”, and each procedure, which is acquired in a case where division is further performed on the major procedure, is referred to as a “sub procedure”.

A series of works performed by the worker are captured by the capturing apparatus 10, the captured data, which indicates the captured work, is transmitted to the information processing apparatus 20. The captured data is accumulated in the database provided in the information processing apparatus 20. The captured data accumulated in the database accompanies various pieces of information such as a type ID indicative of a type of the work, a worker ID used to identify the worker, and an apparatus ID used to identify the capturing apparatus 10 which is a transmission source of the captured data. The captured data of the work, which is captured at different timing or different locations, is accumulated in the database of the information processing apparatus 20 in association with identification information such as the type ID and the worker ID.

In the exemplary embodiment, in a case where the captured data is analyzed by the information processing apparatus 20, the series of works performed by the worker is divided into a plurality of sub procedures. Furthermore, a sub procedure, which is assumed to improve the work efficiency, is selected from the plurality of sub procedures acquired through the division, and is presented to the worker.

A user of the information processing apparatus 20 selects a work type using the UI unit 254 of the information processing apparatus 20. The user of the information processing apparatus 20 is, for example, a worker who performs the captured work, or a manager of the information processing apparatus 20. The UI unit 254 outputs information according to content of an operation performed by the worker.

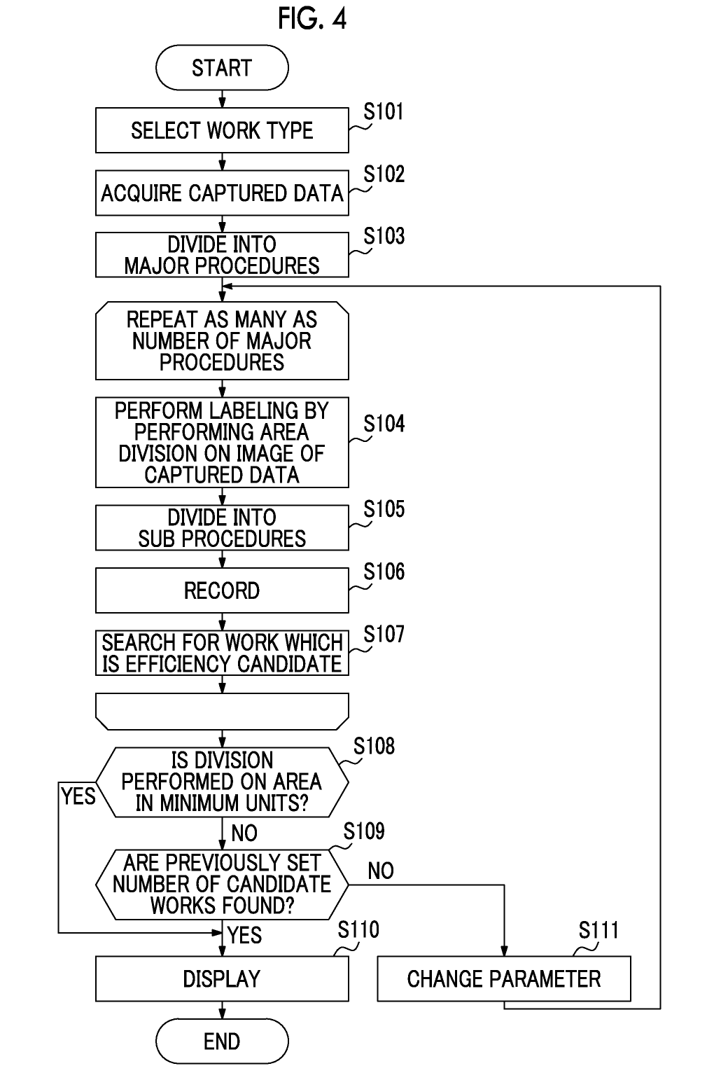

FIG. 4 is a flowchart illustrating a flow of a process of the information processing apparatus 20. Instep S101, the processor 252 of the information processing apparatus 20 selects the work type according to information which is output from the UI unit 254. The work type is information indicative of the type of the work performed by the worker and the work type is, for example, a “xx cartridge exchange work”.

In step S102, the information processing apparatus 20 acquires the captured data which indicates a state of the series of works captured by the capturing apparatus 10. In the acquisition process, for example, the captured data, which is output from the capturing apparatus 10, maybe acquired in real time, or, for example, the captured data corresponding to the identification information, such as the work type, selected by the user may be acquired by reading the database accumulated in the database of the information processing apparatus 20.

In step S103, the information processing apparatus 20 performs a process (hereinafter, referred to as a “major procedure division process”) for dividing the acquired captured data into a plurality of procedures (hereinafter, referred to as “major procedures”). In the exemplary embodiment, in the division process, data (hereinafter, referred to as “division reference data”), which indicates an image used to specify the pause of the work, is used. The division reference data is previously registered by a manager for each major procedure.

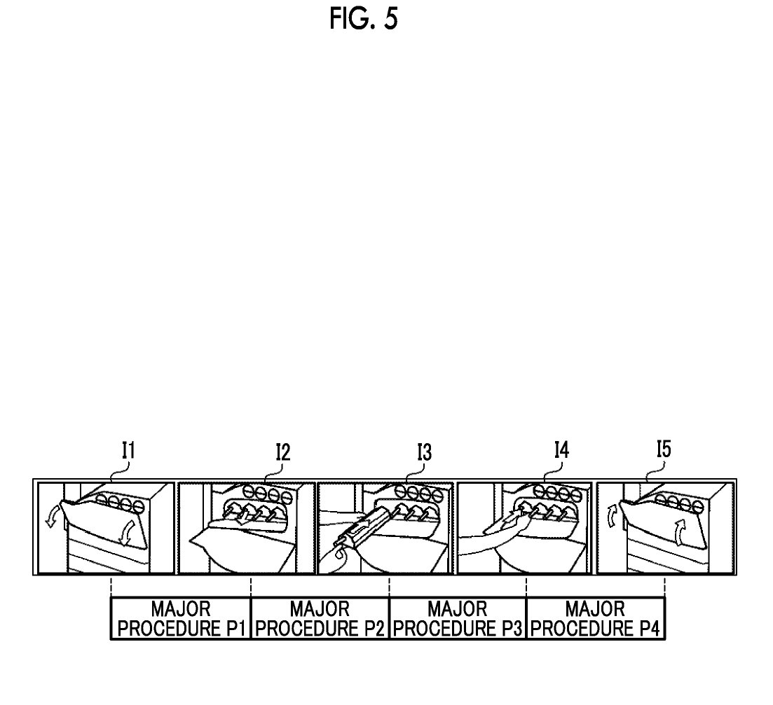

FIG. 5 is a diagram illustrating content of the division reference data. An example of FIG. 5 illustrates the division reference data acquired in a case where major procedures P1 to P4, that is, four major procedures are included as the cartridge exchange work. The major procedure P1 is the procedure for opening the cover, the major procedure P2 is the procedure for extracting the cartridge, the major procedure P3 is the procedure for inserting the cartridge, and the major procedure P4 is the procedure for closing the cover. In FIG. 5, division reference data I1 is image data which indicates a state acquired immediately before the work starts or a state acquired immediately after the work starts. Division reference data I2 is image data which indicates a state in which the major procedure P1 is completed. Division reference data I3 is image data which indicates a state in which the major procedure P2 is completed. Division reference data I4 is image data which indicates a state in which the major procedure P3 is completed. Division reference data I5 is image data which indicates a state in which the major procedure P4 is completed. That is, the division reference data I1 to I5 are data corresponding to pause locations between the major procedures.

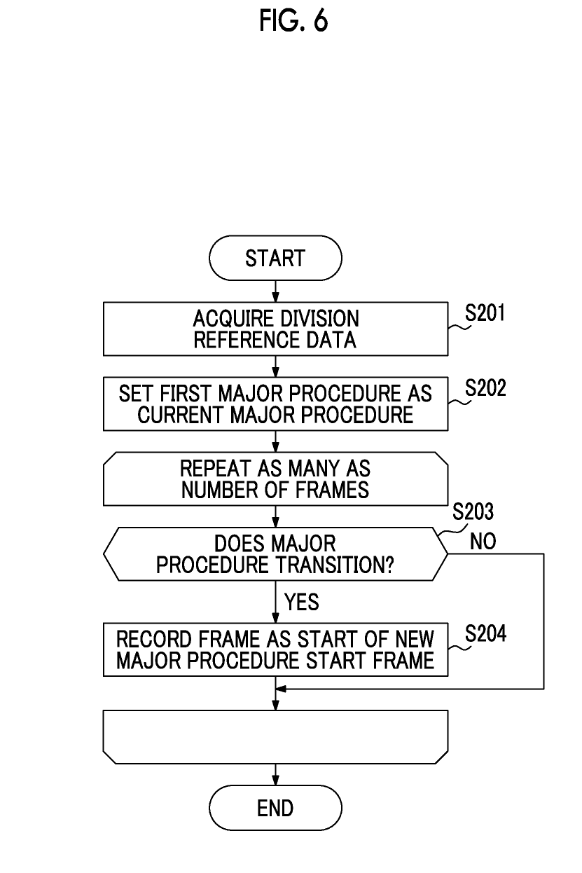

FIG. 6 is a flowchart illustrating a flow of the division process (process of step S103 in FIG. 4) into the major procedures. In step S201, the processor 252 of the information processing apparatus 20 acquires the division reference data which is previously registered for each major procedure. The division reference data may be acquired by being read from the memory 251 of the information processing apparatus 20 or may be acquired by being received from another apparatus through communication IF 253.

In step S202, the information processing apparatus 20 sets a first major procedure as a current major procedure (hereinafter, referred to as a “current procedure”). Subsequently, the information processing apparatus 20 repeats processes in steps S203 and S204 as many as the number of frames of the captured data which is an analysis target. In step S203, the information processing apparatus 20 determines whether or not the major procedure transitions by determining any one of images of the pause locations before and after the current procedure, to which an image of the frame is close. In the exemplary embodiment, the information processing apparatus 20 compares the image of the frame with the division reference data corresponding to current procedure start timing and compares the image of the frame with the division reference data corresponding to current procedure end timing. In a case where a similarity degree of the division reference data corresponding to the end timing is high, the information processing apparatus 20 determines that the major procedure transitions. Specifically, for example, in the example of FIG. 5, in a case where the current procedure is the major procedure P1 and a similarity degree between the image of the frame and the division reference data I1 is lower than a similarity degree between the image of the frame and the division reference data I2, it is determined that transition from the major procedure P1 to the major procedure P2 occurs.

In a case where it is determined that the major procedure transitions (step S203; YES), the information processing apparatus 20 proceeds to the process in step S204. In contrast, in a case where it is determined that the major procedure does not transition (step S203; NO), the information processing apparatus 20 skips the process in step S204, and executes the process in step S203 for the subsequent frame.

In step S204, the information processing apparatus 20 records the frame as a start frame of a subsequent major procedure. As above, a feature of each frame included in the captured data is compared with a feature of the division reference data by the information processing apparatus 20, and the captured data is divided into the plurality of major procedures using a result of the comparison.

Returning to description with reference to FIG. 4. The information processing apparatus 20 repeats processes in steps S104 to S107 as many as the number of major procedures. First, in step S104, the information processing apparatus 20 performs the area division process with respect to the image, which is indicated by the captured data, thereby dividing the image, which is indicated by the captured data, into a plurality of areas (hereinafter, referred to as “partial areas”). Each of the partial areas acquired through the division is labeled.

In step S104, a parameter is used to determine an area division fineness degree (hereinafter, referred to as “granularity”). In the exemplary embodiment, a value of the parameter used for the area division process is set such that the granularity becomes fine as the number of times that the area division process is repeated becomes large (step S111 of FIG. 4).

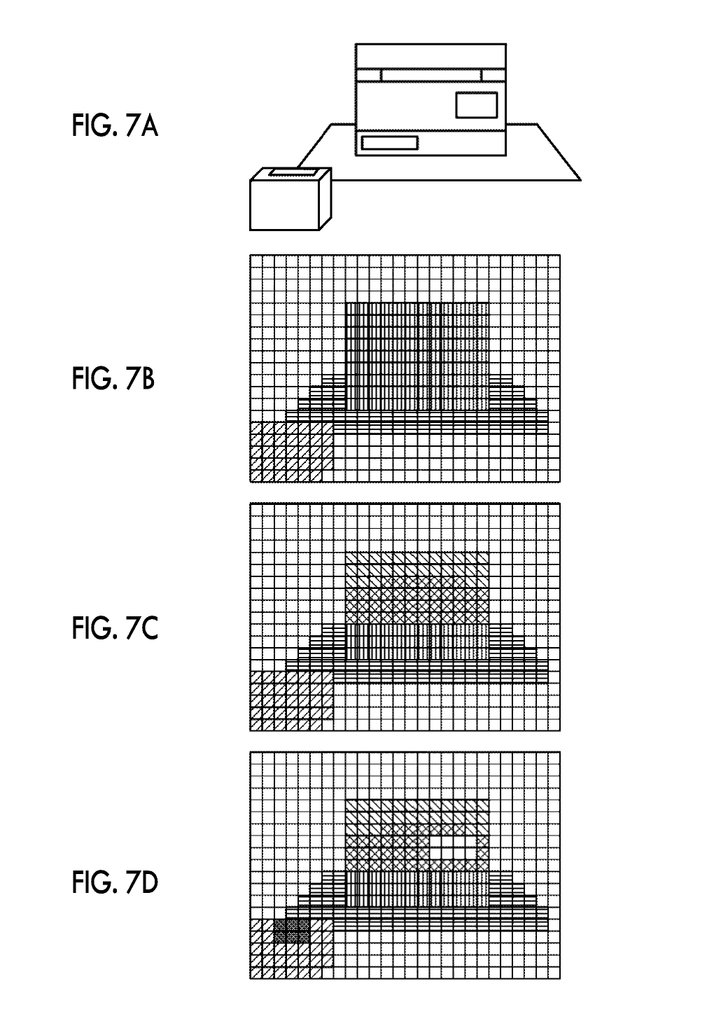

FIGS. 7A to 7D are diagrams illustrating content of the area division process. In FIGS. 7A to 7D, FIG. 7A is a diagram illustrating a field of view of a captured moving image. FIGS. 7B to 7D are diagrams illustrating the respective labeled partial areas. FIG. 7B is a diagram illustrating a result of labeling through a first area division process according to the exemplary embodiment. FIG. 7C is a diagram illustrating a result of labeling through a second area division process. FIG. 7D is a diagram illustrating a result of labeling performed by a third area division process. As being clear in a case where FIGS. 7B and 7C are compared, area division granularity of the second area division process is finer than the first area division process. In addition, granularity of the third area division process is further fine.

Returning to description with reference to FIG. 4. In step S105, the information processing apparatus 20 divides the captured data into data for respective sub procedures (hereinafter, referred to as “unit work data”) at a timing when a parameter relevant to the change in the feature value of an image for each partial area satisfies the predetermined condition.

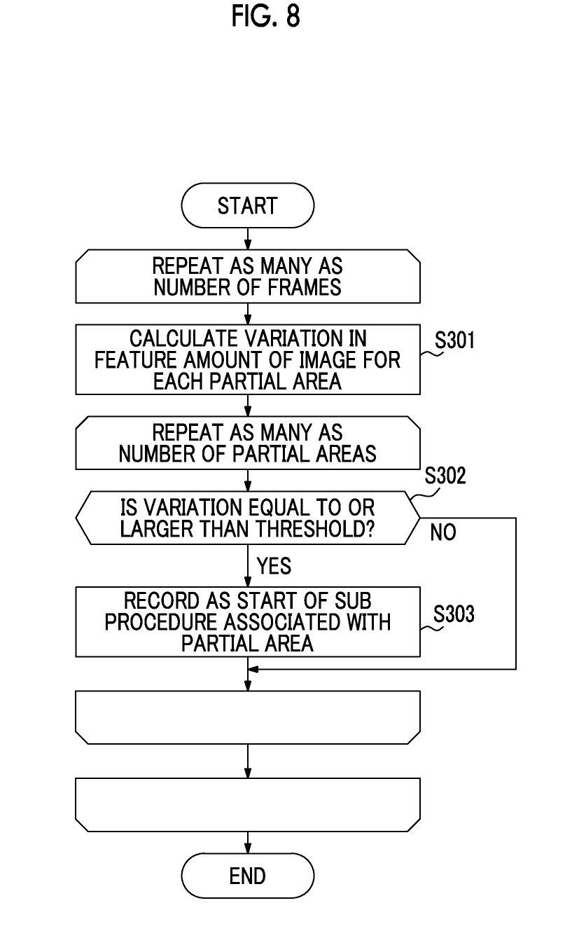

FIG. 8 is a flowchart illustrating a flow of a division process into the sub procedures (the process in step S105 of FIG. 4). In step S301, the information processing apparatus 20 repeats processes in steps S301 to S303 as many as the number of frames. First, in step S301, the information processing apparatus 20 calculates a variation in the feature value of the image for each partial area.

The information processing apparatus 20 repeats the processes insteps S302 and S303 as many as the number of partial areas. First, in step S302, the information processing apparatus 20 determines whether or not the variation in the feature value of the image of the partial area is equal to or larger than the threshold (whether or not the predetermined condition is satisfied). For example, the method, such as the optical flow or the color histogram, is used to determine the variation. In a case where the variation is equal to or larger than the threshold (step S302; YES), the information processing apparatus 20 proceeds to the process in step S303. In contrast, in a case where the variation is smaller than the threshold (step S302; NO), the information processing apparatus 20 skips the process in step S303, and executes the process in step S302 on a subsequent partial area.

In step S303, the information processing apparatus 20 records the frame as a start of the sub procedure associated with the partial area. In the exemplary embodiment, each of the plurality of partial areas is previously associated with a label used to identify a unit work included in the work. In a case where a label assigned to each of the plurality of partial areas is given to the captured data, the captured data is divided into the plurality of sub procedures. In a case where the process in step S303 ends, the information processing apparatus 20 executes the process in step S302 on the subsequent partial area. In a case where the processes in steps S302 and S303 are repeated as many as the number of partial areas, the major procedure is divided into the plurality of sub procedures.

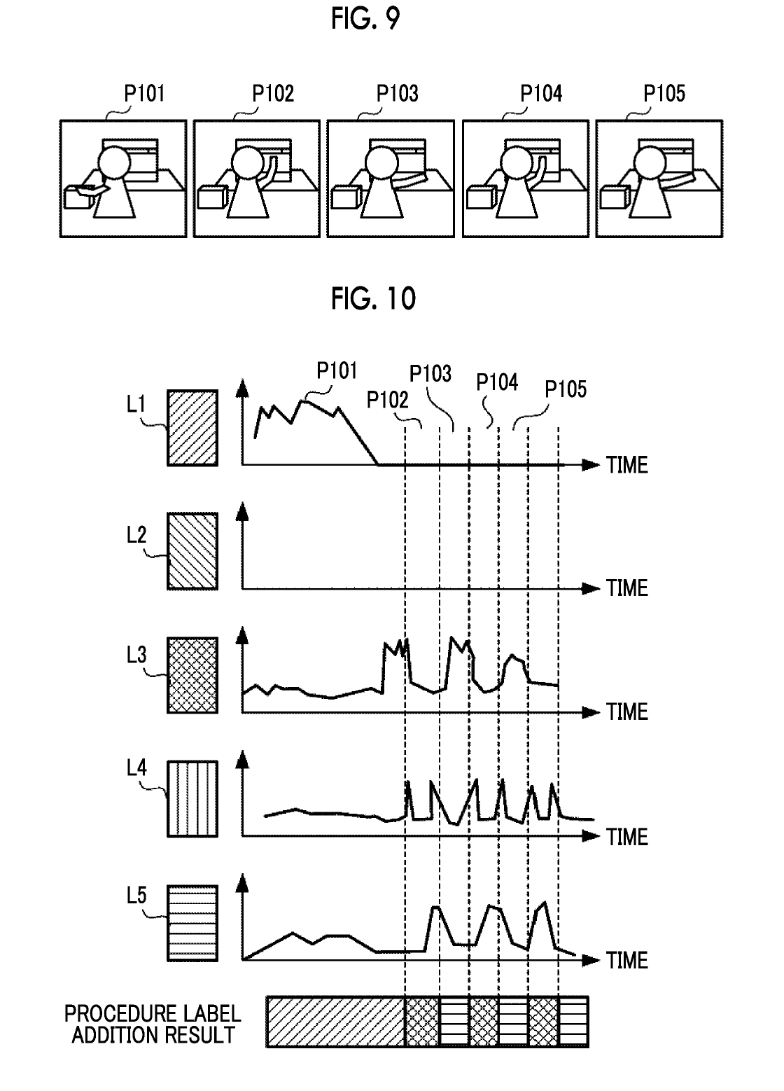

FIG. 9 is a diagram illustrating a flow of the work performed by the worker. An example of FIG. 9 illustrates a case where the sub procedures P101 to P105, that is, five sub procedures are sequentially performed. The sub procedure P101 indicates a procedure in which the worker prepares a driver. The sub procedure P102 indicates a procedure in which the worker loosens the screw. The sub procedure P103 indicates a procedure in which the worker places the screw. The sub procedure P104 indicates a procedure in which the worker loosens the screw. The sub procedure P105 indicates a procedure in which the worker places the screw.

FIG. 10 is a graph illustrating a change in the feature value of the image for each partial area in a case where the captured data, in which the work illustrated in FIG. 9 is captured, is divided into the plurality of partial areas in an aspect illustrated in FIG. 7C. In FIG. 10, in the sub procedure P101, in a case where it is determined that the variation in the feature value of the image of the partial area corresponding to a label L1 is large, the label L1 is attached to the sub procedure P101. In the sub procedure P102, in a case where it is determined that the variation in the feature value of the image of the partial area corresponding to a label L3 is large, the label L3 is attached in the sub procedure P102. In this manner, the label according to the variation is attached to each of the sub procedures. Meanwhile, a plurality of labels may be attached to one sub procedure.

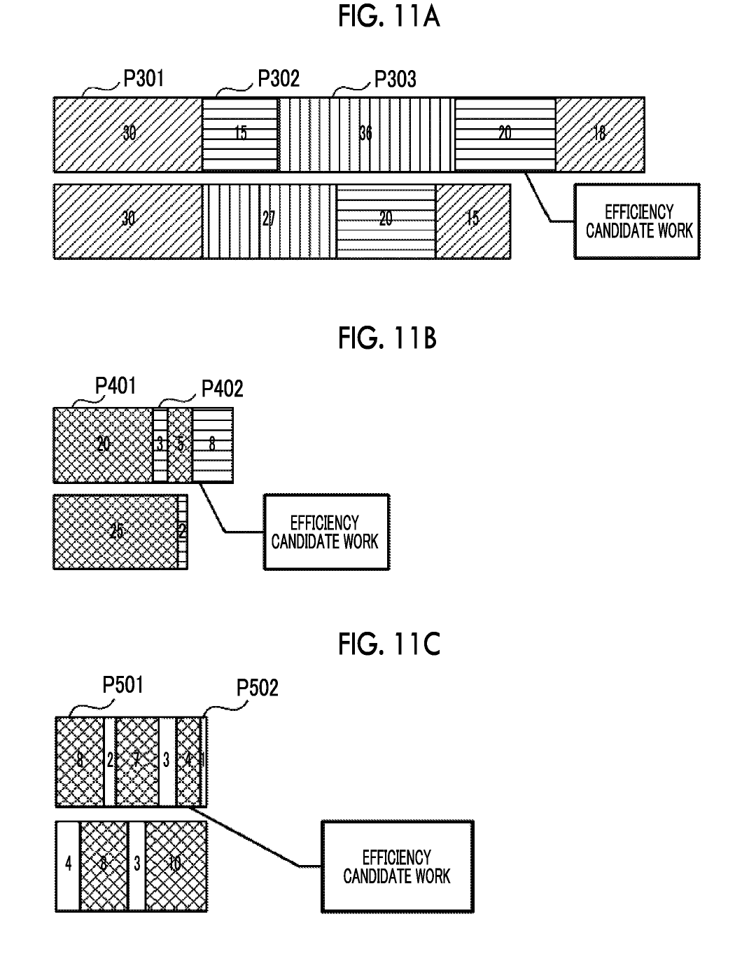

FIGS. 11A to 11C are diagrams illustrating content of the unit work data acquired by dividing the captured data into the sub procedures. In FIGS. 11A to 11C, upper stage graphs are graphs illustrating content acquired by dividing the captured data into the sub procedures. In addition, lower stage graphs are graphs illustrating content of the index data corresponding to the captured data. The index data is the unit work data which is accumulated in the database, and is data whose feature satisfies the predetermined condition (for example, work time is short, the number of times of the work is small, or the like). In FIGS. 11A to 11C, a horizontal axis indicates time. Numerical values in the graphs indicate the work time of the sub procedures. FIG. 11A includes labeled sub procedures P301, P302, and P303, that is, three sub procedures, and it is determined that the sub procedures are performed in order of the sub procedure P301, the sub procedure P302, the sub procedure P303, the sub procedure P302, and the sub procedure P301. That is, each of the works of the sub procedure P301 and the sub procedure P302 is performed after being cut by a plurality number of times.

In FIGS. 11A to 11C, the area division granularity is most coarse in FIG. 11A and is the finest in FIG. 11C. The sub procedure P303 in FIG. 11A is divided into sub procedures P401 and P402 in FIG. 11B. In addition, the sub procedure P401 is further subdivided into sub procedures P501 and P502 in FIG. 11C.

Returning to the description with reference to FIG. 4. In step S106, the information processing apparatus 20 records data indicative of a result of division into the sub procedures. The recording is performed with respect to the database provided in the information processing apparatus 20. In the exemplary embodiment, each work time and/or the number of times of works are recorded. For example, in the example of FIG. 11A, the work time of the sub procedure P301 is “48”, and the number of times of the work is “2”. The work time of the sub procedure P302 is “35”, and the number of times of the work is “2”. The work time of the sub procedure P303 is “36”, and the number of times of the work is “1”.

In step S107 of FIG. 4, the information processing apparatus 20 searches the plurality of sub procedures, which are acquired through the division, for a sub procedure in which the feature of the unit work data corresponding to the sub procedure satisfies the predetermined condition. The feature of the unit work data includes, for example, the work time or the number of times of the work. The unit work data, which is found in step S107, is presented to the user, such as the worker or the manager, as the sub procedure which has high improvement efficiency. In the description below, the sub procedure, which is assumed to have the high improvement efficiency, is referred to as a “candidate work” for convenience of the description.

In the exemplary embodiment, a search process is performed using the index data previously prepared for each sub procedure. The index data is selected from past captured data accumulated in the database of the information processing apparatus 20.

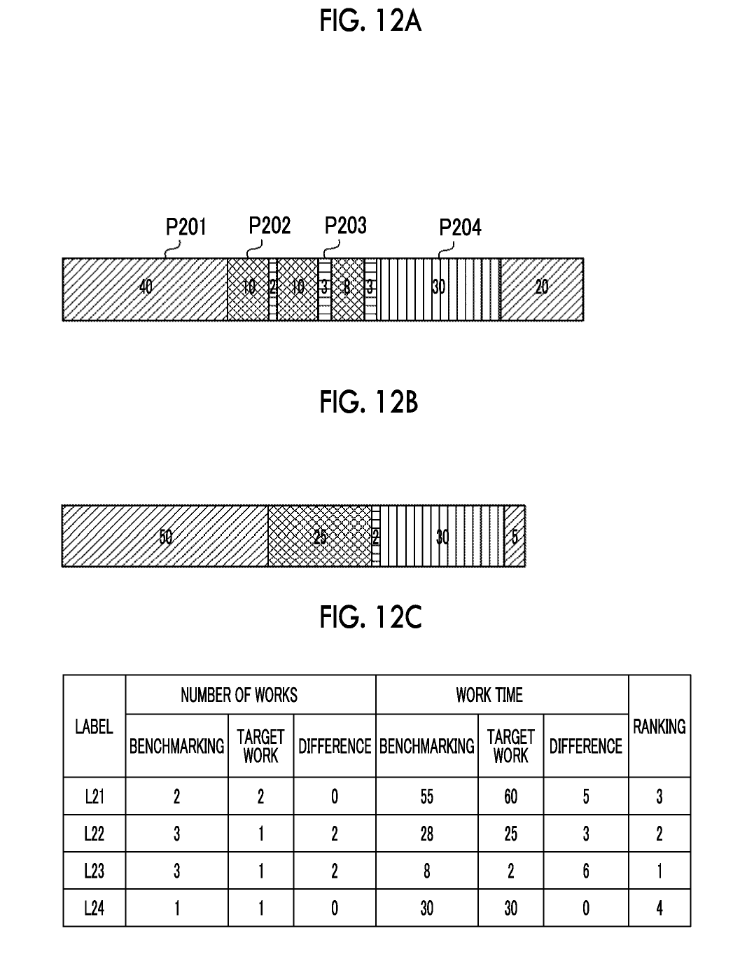

FIGS. 12A to 12C are diagrams illustrating a candidate work extraction process in step S107. In FIGS. 12A to 12C, FIG. 12A is a diagram illustrating a label, which is attached to each of the unit work data (hereinafter, referred to as “evaluation target data”) that is an evaluation target, and work time of each unit work data. In FIGS. 12A to 12C, a label L21 is attached to a sub procedure P201, and the work time thereof is 40 (sec). A label L22 is attached to a sub procedure P202, and the sub procedure P202 is executed after being divided into three. The work time of the sub procedure P202 is 28 (sec).

FIG. 12B is a diagram illustrating the unit work data selected as the index data by the information processing apparatus 20. In the exemplary embodiment, the information processing apparatus 20 extracts the index data corresponding to the label, which is attached to the unit work data of the sub procedure acquired through division in step S105, from the past captured data which is recorded in the database of the information processing apparatus 20. In the operation example, the unit work data based on a predetermined index, in which total work time is short, is extracted as the index data.

The information processing apparatus 20 compares the feature of the unit work data, which is acquired by dividing the captured data, with a feature of the index data corresponding to the label attached to the unit work data, and specifies the unit work data in which the difference between the features is equal to or larger than the predetermined threshold (satisfies the predetermined condition).

FIG. 12C is a diagram illustrating a result of the comparison between the evaluation target data and the index data for each label. In the example, the number of times of the work and the total work time are compared for each of the sub procedures, and ranking is determined in decreasing order of the difference therebetween. In the exemplary embodiment, the information processing apparatus 20 specifies a work corresponding to the partial area, in which the number of times of the work and/or the total work time is large compared to the index data, as the candidate work.

In examples of FIGS. 12A to 12C, in a case where there is no difference with the index data for the number of times of the work or the order, the candidate work is not selected. In this case, the information processing apparatus 20 executes the processes in steps S104 to S107 of FIG. 4 for the subsequent major procedure. In a case where the processes in steps S104 to S107 are repeatedly executed as many as the number of major procedures, one or more candidate works are specified. Meanwhile, there is a case where the candidate work is not specified according to content of the captured data and the index data.

Returning to the description with reference to FIG. 4. In step S108, the information processing apparatus 20 determines whether or not the area division is performed using granularity in a minimum unit which is previously set by the user. The minimum unit is previously set in the information processing apparatus 20 by the user such as a manager. In a case where it is determined that the area division is performed in the minimum unit (step S108; YES), the information processing apparatus 20 proceeds to a process in step S110. In contrast, in a case where the area division is not performed yet in the minimum unit (step S108; NO), the information processing apparatus 20 proceeds to a process in step S109.

In step S109, the information processing apparatus 20 determines whether or not a previously set number of candidate works are found. The number of candidate works is previously set in the information processing apparatus 20 by the user such as the manager. In a case where a predetermined number of candidate works are found (step S109; YES), the information processing apparatus 20 proceeds to the process in step S110. In contrast, in a case where a predetermined number of candidate works are not found (step S109; NO), the information processing apparatus 20 proceeds to a process in step S111.

In step S111, the information processing apparatus 20 changes the value of the parameter which is used in step S104. In a case where the process in step S111 ends, the information processing apparatus 20 returns to the process in step S104. That is, in the exemplary embodiment, in a case where the difference between the evaluation target data and the index data is smaller than the predetermined threshold, the information processing apparatus 20 executes the division process again using a value, in which the division fineness degree (granularity) is finer than the value of the parameter used in a case where the area division process is executed in last time.

In step S110, the information processing apparatus 20 presents the candidate works by displaying information indicative of the candidate works, which are found in step S107, on the UI unit 254. Meanwhile, a presenting method is not limited to the display. For example, the candidate works may be presented using voice.

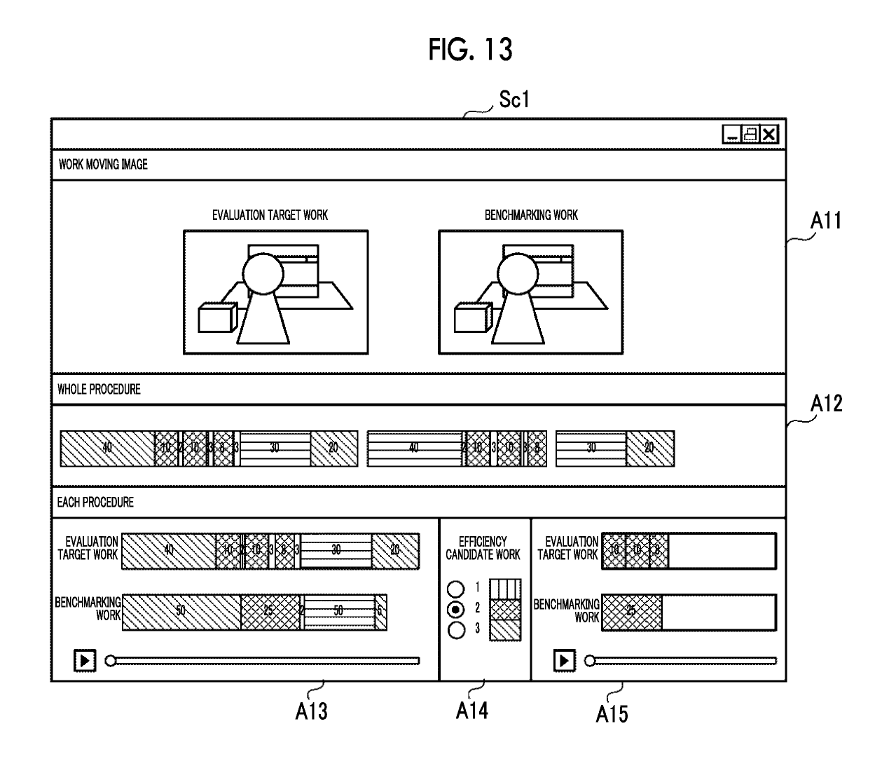

FIG. 13 is a diagram illustrating a screen which is displayed on the UI unit 254 in step S110. In an example of FIG. 13, the screen Sc1 includes display areas A11 to A15. In the display area A11, a moving image indicative of the captured data, which is the evaluation target, and a moving image (benchmarking work) indicative of the index data are displayed. In the display area A12, the work time for each of the sub procedures, which are included in the whole procedure, is displayed. In the display area A13, the work time of the evaluation target work, and the work time of the work (benchmarking work) corresponding to the index data are displayed in a comparable form.

In the display area A14, a list of the sub procedures, which are extracted as the candidate works, is displayed. The user is capable of performing an operation for selecting any one of the sub procedures included in the displayed list. In the display area A15, the evaluation target work for the sub procedure, which is selected in the display area A14, and the benchmarking work are displayed in a comparable form. The user grasps the sub procedure to be improved using the screen. In addition, the user easily grasps a method for improving the work in detail using the screen as in a case where, for example, work time is reduced by performing the sub procedures all together instead of dividing and performing the sub procedures by a plurality number of times.

However, in a work support system according to the related art, there is a case where it is difficult to grasp detailed improvement content in a case where the division fineness degree (hereinafter, referred to as the “granularity”), which is acquired in a case where the captured data is divided into the plurality of procedures, is too large. In contrast, in a case where the granularity is too fine, there is a case where the number of presented candidate works is too large or the improvement efficiency is limited.

In contrast, in the exemplary embodiment, the work procedure is divided into hierarchies using work granularity, and the number of times and time for each work procedure are sequentially recorded from an upper hierarchy. In addition, the index data is extracted from the past data based on the index, in which the total work time is short, and the number of times of the works and/or the work corresponding to the partial area, in which the number of times of the works is large, are presented as the candidate work to the worker or the like through comparison with the index data. Therefore, the user easily grasps a detailed improvement method of the work.

In addition, in the exemplary embodiment, in a case where a predetermined number of candidate works are not found, each sub procedure is broken down into sub procedures which are further fine, and candidate works, which are specified through comparison with the index data of respective procedures, are presented to the worker. As above, in the exemplary embodiment, the works to be improved by the worker are sequentially presented from a more effective work without requesting the user to register the work procedure.

In addition, in the exemplary embodiment, the whole work is separated into a plurality of major procedures, and thus it is easy to accurately present a work which may be effective. For example, in the operation for loosening the screw and the operation for fastening the screw, another work is performed after loosening the screw. Therefore, the works with respect to a common partial area are not even successively performed. Here, in a case where the screw is taken off and a state in which a part is taken off is made, the procedure is paused, with the result that the work until the screw is taken off is separated from the work performed after the screw is taken off, and thus the efficiency in each major procedure is propelled.

3. Modification Example

The above-described exemplary embodiment is only one example of the present invention, and may be modified as below. In addition, the above-described exemplary embodiment and each modification example below may be implemented by being combined with each other if necessary.

(1) In the above-described exemplary embodiment, in the major procedure division process (process in step S103 of FIG. 4), the process for dividing into the major procedures is performed by comparing the division reference data with the image data of the frame in the pause locations before and after each major procedure. A method for determining whether or not the major procedure transitions is not limited to the method illustrated in the above-described exemplary embodiment. For example, the information processing apparatus 20 may calculate the similarity degree between the feature value of the image of each frame and the feature value of the division reference data corresponding to the pause location with the subsequent procedure, and may determine that the major procedure transitions in a case where the similarity degree is equal to or larger than the predetermined threshold.

(2) In the above-described exemplary embodiment, the captured data is divided into the plurality of sub procedures according to the variation in the feature value of the image for each partial area. A method for dividing the captured data into sub procedures is not limited to the method illustrated in the above-described exemplary embodiment. For example, the information processing apparatus 20 may calculate a variation rate of the feature value of the image for each partial area, and may specify start of the sub procedure corresponding to the partial area in a case where the variation rate is equal to or larger than the predetermined threshold.

(3) In the above-described exemplary embodiment, a case where the screen illustrated in FIG. 13 is displayed is illustrated as a method for presenting the selected candidate works. The method for presenting the selected candidate works is not limited to the method illustrated in the above-described exemplary embodiment. For example, the moving image of the benchmarking work is not displayed, and the moving image of the benchmarking work may be displayed in a case where the moving images of the candidate works are displayed.

(4) In the above-described exemplary embodiment, data indicative of a result of the division process into the sub procedures and data indicative of the candidate works may be recorded after being combined. In this case, in a case where analysis is performed again on the user's work, display may be performed such that the candidate works, which are presented last time, can be known, together with the benchmarking work. That is, the information processing apparatus 20 stores a candidate work selection history in the database, and, in a case where a moving image of the candidate work is displayed, the image indicated by the unit work data specified by the history corresponding to the candidate work may be displayed together.

(5) In the above-described exemplary embodiment, feedback from a work presented as the candidate work may be input by the worker. For example, in a case of being highly effective or in a case of actually not improving the efficiency, data which notifies the gist is recorded in association with data indicative of the candidate work. Therefore, control may be performed in subsequent analysis such that a work which is highly effective in the past is preferentially presented and a work of low effect is not presented.

(6) In the above-described exemplary embodiment, the program which is executed by the processor 252 of the information processing apparatus 20 maybe downloaded through the communication line such as the Internet. In addition, the program may be provided in a state of being recorded in a computer-readable recording medium such as a magnetic recording medium (a magnetic tape, a magnetic disk, or the like), an optical recording medium (optical disk or the like), a magneto-optical recording medium, or a semiconductor memory.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an area division unit that performs an area division process with respect to an image indicated by captured data acquired by capturing a state of a work performed by a worker, and that divides the image into a plurality of partial areas;
a captured data division unit that divides the captured data into a plurality of unit work data at a timing when a parameter relevant to a change in a feature value of the image for each of the partial areas satisfies a predetermined condition;
a selection unit that selects the unit work data having a feature, which satisfies the predetermined condition, from the plurality of unit work data; and
a presentation unit that presents the selected unit work data.

2. The information processing apparatus according to claim 1,
wherein each of the plurality of partial areas is associated with a unit work included in the work, and
wherein the feature of the unit work data is at least any one of work time or the number of times of the unit work.

3. The information processing apparatus according to claim 1,
wherein the captured data division unit gives a label, which is assigned to each of the partial areas, to the unit work data, and
wherein the selection unit compares the feature of the unit work data with a feature of index data corresponding to the label given to the unit work data, and specifies the unit work data in which a difference between the features is equal to or larger than a predetermined threshold.

4. The information processing apparatus according to claim 2,
wherein the captured data division unit gives a label, which is assigned to each of the partial areas, to the unit work data, and
wherein the selection unit compares the feature of the unit work data with a feature of the index data corresponding to the label given to the unit work data, and specifies the unit work data in which a difference between the features is equal to or larger than a predetermined threshold.

5. The information processing apparatus according to claim 3,
wherein the selection unit instructs the area division unit to execute the area division process in a case where the difference is smaller than the predetermined threshold, and
wherein the area division unit executes the area division process using the parameter, which causes a division degree to be finer than a case where the area division process is executed last time, in a case where the area division process is instructed.

6. The information processing apparatus according to claim 4,
wherein the selection unit instructs the area division unit to execute the area division process in a case where the difference is smaller than the predetermined threshold, and
wherein the area division unit executes the area division process using the parameter, which causes a division degree to be finer than a case where the area division process is executed last time, in a case where the area division process is instructed.

7. The information processing apparatus according to claim 3, further comprising:
an extraction unit that extracts the index data corresponding to the label given to the unit work data acquired through division from a database which stores the plurality of captured data.

8. The information processing apparatus according to claim 4, further comprising:
an extraction unit that extracts the index data corresponding to the label given to the unit work data acquired through division from a database which stores the plurality of captured data.

9. The information processing apparatus according to claim 5, further comprising:
an extraction unit that extracts the index data corresponding to the label given to the unit work data acquired through division from a database which stores the plurality of captured data.

10. The information processing apparatus according to claim 6, further comprising:
an extraction unit that extracts the index data corresponding to the label given to the unit work data acquired through division from a database which stores the plurality of captured data.

11. The information processing apparatus according to claim 1, further comprising:
a procedure division unit that compares the captured data with division reference data indicative of an image used to specify a pause of the work, and divides the captured data into a plurality of procedures using a result of the comparison,
wherein the selection unit selects the unit work data for each procedure acquired through the division.

12. The information processing apparatus according to claim 2, further comprising:
a procedure division unit that compares the captured data with division reference data indicative of an image used to specify a pause of the work, and divides the captured data into a plurality of procedures using a result of the comparison,
wherein the selection unit selects the unit work data for each procedure acquired through the division.

13. The information processing apparatus according to claim 3, further comprising:
a procedure division unit that compares the captured data with division reference data indicative of an image used to specify a pause of the work, and divides the captured data into a plurality of procedures using a result of the comparison,
wherein the selection unit selects the unit work data for each procedure acquired through the division.

14. The information processing apparatus according to claim 4, further comprising:
a procedure division unit that compares the captured data with division reference data indicative of an image used to specify a pause of the work, and divides the captured data into a plurality of procedures using a result of the comparison,
wherein the selection unit selects the unit work data for each procedure acquired through the division.

15. The information processing apparatus according to claim 5, further comprising:
a procedure division unit that compares the captured data with division reference data indicative of an image used to specify a pause of the work, and divides the captured data into a plurality of procedures using a result of the comparison,
wherein the selection unit selects the unit work data for each procedure acquired through the division.

16. The information processing apparatus according to claim 6, further comprising:
a procedure division unit that compares the captured data with division reference data indicative of an image used to specify a pause of the work, and divides the captured data into a plurality of procedures using a result of the comparison,
wherein the selection unit selects the unit work data for each procedure acquired through the division.

17. The information processing apparatus according to claim 7, further comprising:
a procedure division unit that compares the captured data with division reference data indicative of an image used to specify a pause of the work, and divides the captured data into a plurality of procedures using a result of the comparison,
wherein the selection unit selects the unit work data for each procedure acquired through the division.

18. The information processing apparatus according to claim 3,
wherein the presentation unit displays an image indicated by the selected unit work data and an image indicated by the index data in a comparable form.

19. The information processing apparatus according to claim 18, further comprising:
a storage control unit that stores history of selection performed by the selection unit,
wherein the presentation unit displays the image indicated by the unit work data specified by history corresponding to the selected unit work data, together with the image indicated by the selected unit work data.

20. A non-transitory computer readable medium storing a program causing a computer to execute a process, the process comprising:
performing an area division process with respect to an image indicated by captured data acquired by capturing a state of a work performed by a worker, and dividing the image into a plurality of partial areas;
dividing the captured data into a plurality of unit work data at a timing when a parameter relevant to a change in a feature value of the image for each of the partial areas satisfies a predetermined condition;
selecting the unit work data having a feature, which satisfies the predetermined condition, from the plurality of unit work data; and
presenting the selected unit work data.
